(19) United States
(12) Patent Application Publication
(10) Pub. No.: US 2024/0329985 A1
(43) Pub. Date: Oct. 3, 2024

(54) System and Technique for Constructing Manufacturing Event Sequences and their Embeddings for Clustering Analysis

(71) Applicant: Robert Bosch GmbH, Stuttgart (DE)

(72) Inventors: HyeongSik Kim, San Jose, CA (US); Sarwan Ali, Atlanta, GA (US); Andrew Le Clair, London (CA)

(21) Appl. No.: 18/194,039

(22) Filed: Mar. 31, 2023

(51) Int. Cl. G06F 9/30; G06F 9/54

(52) U.S. Cl. CPC G06F 9/30036; G06F 9/542

(57) ABSTRACT

A system and methods for event analysis are disclosed. The system and methods can be employed analyze at least one event data stream from a monitored system. The system and methods advantageously leverage two novel embedding pipelines to enable event sequences extracted from the event data stream to be more effectively clustered and mined for patterns, thereby enabling a better understanding of the event sequences. As a result, the system and methods better assist operators and engineers in studying the cause-and-effect relationships between events so that they can prevent undesirable events from occurring in the monitored system.

### FIELD

The device and method disclosed in this document relates to system event analysis and, more particularly, to constructing event sequences and their embeddings for clustering analysis.

### BACKGROUND

Unless otherwise indicated herein, the materials described in this section are not admitted to be the prior art by inclusion in this section.

Modern manufacturing plants often produce many different types of data as streams, such as event logs from their lines. By collecting and analyzing such event logs, on-site engineers wish to understand the impact and the patterns of the events in the logs and further minimize any critical events that could cause interruptions of their manufacturing lines. Analyzing event sequences is a challenging problem due to the high volume of the events in the streams. The engineers might be able to review the sequences manually, but it would be extremely time-consuming for them to determine if there are any frequent common patterns or notable anomalies within sequences. Moreover, it is often necessary to quickly analyze such data and make prompt runtime decisions.

One common approach to fulfill this need is using pattern mining techniques that collect event patterns from logs. However, the number of patterns is often still huge; thus, analyzing the patterns still requires extensive effort. For this reason, other methods that could quickly summarize the event patterns are also used, such as applying clustering techniques over event sequences represented in event logs. However, raw sequences are not in a numerical form. They also have variable lengths, and the events among different sequences are not aligned, making clustering on such data very challenging because clustering methods require fixed-length numerical vectors as input. In past years, several efforts have been made to design fixed-length feature vector representations for sequence-based data. Some of those methods involve an expensive training process, while others do not capture all implicit information from the sequences. Therefore, such methods are not yet generally used to make runtime decisions.

Recent research has proposed methods to classify and/or cluster the unstructured data using feature engineering and deep learning. Feature engineering-based methods, such as one-hot encoding are proven to be computationally efficient. However, they do not capture all (hidden) information and patterns from the data. Similarly, deep learning-based models, such as DeepCluster are computationally expensive as they require an expensive training process, but they are proven to perform better than traditional feature engineering models. The feature engineering models, in general, are proven to perform better than deep learning models in the case of tabular data, along with less computational complexity, reliability, and explainability properties. Moreover, the majority of the feature engineering deep learning methods are not alignment-free, i.e., one-to-one mapping of values in different sequences based on time or any other factor is not present. Similarly, most feature engineering methods do not preserve the order of values within a sequence, hence affecting the performance of the underlying clustering/classification algorithm. Some recent research tries to perform sequence analysis in different geometric space, such as Euclidean, latent, and hyperbolic space. However, it is unclear whether any geometric space could be generalized to different (other) types of sequence-based data.

These techniques are generally not suitable for systems such as real-world manufacturing plants, in which the engineers often need to make decisions on-the-fly. Hence, both fast and accurate decision-making is required (which most feature engineering models lack in general). Moreover, the underlying model is expected to give reliable and interpretable results, which is expensive (if possible at all) in most deep learning models. If predictive results are not reliable, hard to interpret, or require too much computational time, the engineers may not be able to utilize the results within effective time period.

### SUMMARY

A method for analyzing events in a system is disclosed. The method comprises receiving, with a processor, event data from the system. The event data indicates events that occurred in the system and times at which the events occurred. The method further comprises determining, with the processor, a plurality of event sequences from the event data. The plurality of event sequences have variable lengths. The method further comprises determining, with the processor, a plurality fixed-length embeddings of the plurality of event sequences. The method further comprises performing, with the processor, a cluster analysis of the fixed-length embeddings to determine a plurality of clusters of event sequences in the plurality of event sequences.

### BRIEF DESCRIPTION OF THE DRAWINGS

The foregoing aspects and other features of methods are explained in the following description, taken in connection with the accompanying drawings.

FIG. 1 shows exemplary components of an event analysis system.

FIG. 2 shows a method for performing a cluster analysis of event sequences in a system.

FIG. 3 depicts an event sequence on a partial timeline.

FIG. 4 summarizes the preprocessing of event sequences and parameter sequences in fixed-length k-mers.

FIG. 5 summarizes the processing for the ESE-E embedding pipeline.

FIG. 6 summarizes the processing for the ESE-L embedding pipeline.

FIG. 7 shows exemplary graphical representations of clusters of event sequences.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

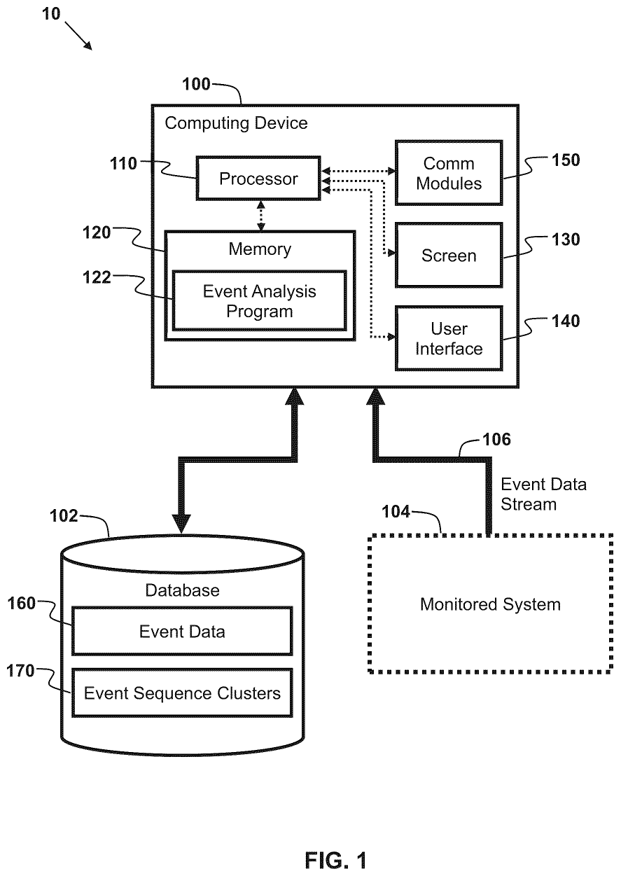

FIG. 1 shows an event analysis system 10 according to the disclosure. The event analysis system 10 is configured to analyze at least one event data stream 106 from a monitored system 104. As will be discussed in greater detail below, the event analysis system 10 advantageously leverages two novel embedding pipelines to enable event sequences extracted from the event data stream to be more effectively clustered and mined for patterns, thereby enabling a better understanding of the event sequences. As a result, event analysis system 10 better assists operators and engineers in studying the cause-and-effect relationships between events so that they can prevent undesirable events from occurring in the monitored system 104.

Throughout the disclosure, the monitored system 104 will be described primarily using the illustrative example of a manufacturing plant having a plurality of machines, with respect to which various events may occur and which are monitored to generate event data. However, it should be appreciated that the event analysis system 10 may be applied to any system that generates event data, either through self-monitoring or through some other monitoring mechanism.

In the illustrative example, the monitored system 104 is a manufacturing plant that includes a plurality of machines. The machines of the manufacturing plant may, for example, include welding stations, storage tanks, mixers, compressors, centrifuges, etc. These machines are each installed at a specific location in the manufacturing plant and with a particular configuration. The machines may be interlinked with each other, forming lines of the machines. In each line of machines, the output of the machines may be automatically fed as input for the next machines in the line so that the manufacturing process can be fully automated. As used here, the term “location” of the machine is not limited to its literal meaning, but instead denotes the “machine” running or operating at a specific physical location using a specific configuration (e.g., function unit, work position, and tool positions). Each location can, therefore, be identified using a unique identifier so that it can be identified and selected in databases or other software systems. Each location continuously emits different types of event data as it operates, such as anomalies, interruptions, and other types of event data over time via one or more monitoring systems in the manufacturing plant. The data provided from each location or machine is provided as an event data stream 106 to a computing device 100 of the event analysis system 10.

Thus, the event data stream 106 at least includes data indicating events that occurred in the monitored system 104 and timestamps indicating the times at which the events occurred. As used herein, an “event” denotes any single discrete moment that occurs with respect to a system at a particular time. Events can be categorized into any number of different event types, depending on the nature of the system (i.e., monitored system 104). In the illustrative example of a manufacturing plant, an event refers to any single discrete moment that occurs a specific location, machine, and/or component at a manufacturing plant, at a particular time. For example, suppose that the manufacturing plant includes a welding machine w located at the manufacturing line m. Suppose that event e₁ happens with respect to the welding machine w at a certain specific time, e.g., 2018 Jun. 12 09:55:22. The event e₁ may, for example, be that a sensor of the welding machine w indicates that some measured parameter has an abnormal value. Subsequently, another event e₂ happens with respect to the welding machine w at a certain specific time, e.g., 2018 Jun. 12 10:51:02. The event e₂ may, for example, be that the operation of this machine w has been interrupted, i.e., its operation has suddenly stopped. From this example, the events e₁ and e₂ can be logically categorized into two event types: “anomalies” (i.e., the event e₁) and “interruptions” (i.e., the event e₂).

As used herein, an “anomaly” is an event denoting a moment when any measurable or observable parameter from any location or any component of a system behaves abnormally, e.g., has an irregular value outside of a predetermined or expected range, or a value trending toward becoming outside of the predetermined or expected range. The predetermined or expected range may be fixed or based on an observed trend for the parameter. In the manufacturing plant example, a temperature of some chamber of some machines being out of a predetermined allowed range, or a velocity of a rotating axis in some other machine being lower than its average speed, might be reported as an anomaly in the event data stream 106.

As used herein, an “interruption” is an event denoting a moment when a process of a system is halted, e.g., due to a failure of some component of the system or due to intervention by a human operator or an automated intervention system. In the manufacturing plant example, interruptions could cause a delay of the manufacturing line/process. These delays could result in a halting of manufacturing parts, and has a quantifiable monetary impact, in addition to requiring intervention by experts (e.g., line operators) to address what caused the interruption.

It should be appreciated that anomalies and interruptions are mere exemplary event types and, although this classification scheme is used herein to describe the events of the event data stream 106, it should be appreciated that events can be categorized into any number of different event types. In a broad manner, the combination of other event types can also be similarly used with other scenarios, set-ups, configurations, or domains. For example, instead of using anomalies from anomaly detection engines, any other event type, such as warnings or precursor events, can be used as alternatives. Such event types can be also a component-change event (i.e., some components in machines are often worn out as it operates over time, which need some replacements) or any other alerts from any other monitoring systems installed in locations or plants. Similarly, instead of using interruptions, other critical event types can be used here, such as scrap-detection events (i.e., the components or products built from the machines were not properly manufactured, which need to be discarded) or any other malfunctions of the stations which need to be prevented in advance.

In at least some embodiments, in addition to the data indicating events that occurred in the monitored system 104 and the timestamps indicating the times at which the events occurred, the event data stream 106 may further include certain metadata, such as where the event occurred, what caused the event, what sensors detected the event, a human-input text description of the event, an indication of whether the event was a planned or unplanned interruption, a duration of the event, and other parameters or contextual information etc. The event analysis system 10 is configured to analyze and store the data of the event data stream 106 in a database 102.

### Exemplary Hardware Embodiment

With continued reference to FIG. 1, an exemplary embodiment of the computing device 100 is described that can be used to analyze the event data stream 106 from the monitored system 104. The computing device 100 comprises a processor 110, a memory 120, a display screen 130, a user interface 140, and at least one network communications module 150. It will be appreciated that the illustrated embodiment of the computing device 100 is only one exemplary embodiment is merely representative of any of various manners or configurations of a server, a desktop computer, a laptop computer, mobile phone, tablet computer, or any other computing devices that are operative in the manner set forth herein. The computing device 100 is in communication with the database 102, which may be hosted by another device or which is stored in the memory 120 of the computing device 100 itself.

The processor 110 is configured to execute instructions to operate the computing device 100 to enable the features, functionality, characteristics and/or the like as described herein. To this end, the processor 110 is operably connected to the memory 120, the display screen 130, and the network communications module 150. The processor 110 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 100 to perform various operations described herein. The memory 120 may be of any type of device capable of storing information accessible by the processor 110, such as a memory card, ROM, RAM, hard drives, discs, flash memory, or any of various other computer-readable medium serving as data storage devices, as will be recognized by those of ordinary skill in the art.

The display screen 130 may comprise any of various known types of displays, such as LCD or OLED screens, configured to display graphical user interfaces. The user interface 140 may include a variety of interfaces for operating the computing device 100, such as buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes an ethernet adaptor or a Wi-Fi® module configured to enable communication with a wired or wireless network and/or router (not shown) configured to enable communication with various other devices. Additionally, the network communications module 150 may include a Bluetooth® module (not shown), as well as one or more cellular modems configured to communicate with wireless telephony networks.

In at least some embodiments, the memory 120 stores program instructions of an event analysis program 122 that can be used to analyze the event data stream 106 from the monitored system 104. In at least some embodiments, the database 102 stores a plurality of event data 160, which includes the raw data indicating events that occurred in the monitored system 104, the timestamps indicating the times at which the events occurred, and the various metadata discussed above. Additionally, the database 102 stores one or more event sequence clusters 170 that are leveraged by event analysis program 122 to analyze the event data stream 106, including displaying the event sequence clusters to a user for review and study.

### Methods for Embedding and Clustering Event Sequences

A variety of operations and processes are described below for operating the computing device 100 to analyze an event data stream 106, including performing a cluster analysis of event sequences in the monitored system 104 and displaying the event sequence clusters to a user for review and study. In these descriptions, statements that a method, processor, and/or system is performing some task or function refers to a controller or processor (e.g., the processor 110 of the computing device 100) executing programmed instructions stored in non-transitory computer readable storage media (e.g., the memory 120 of the computing device 100) operatively connected to the controller or processor to manipulate data or to operate one or more components in the computing device 100 or of the database 102 to perform the task or function. Additionally, the steps of the methods may be performed in any feasible chronological order, regardless of the order shown in the figures or the order in which the steps are described.

For a better understanding of the problems that might be solved using the event sequence embedding and clustering, the methods are described with respect to the illustrative example in which the monitored system 104 is a manufacturing plant having a plurality of machines, with respect to which various events may occur and which are monitored to generate event data. In the illustrative example, the methods embed and cluster event sequences formed from two exemplary event types (anomalies and interruptions) so that the users of the event sequence clustering (operators in manufacturing plants) analyze the event sequences. However, it should be appreciated that the systems and methods described herein can be applied to any domain and the references herein to the manufacturing domain and terminologies thereof should be understood to be merely exemplary.

It should be appreciated that analyzing raw event sequences using clustering to determine their similarities is not trivial. Particularly, in the illustrative embodiment of a manufacturing plant, the raw event sequences consist of two different event types: interruptions, and anomalies. Additionally, the events have numerous metadata and/or parameters associated therewith that are not directly represented in the raw event sequence, such that directly processing the raw event sequences would not properly incorporate the information in the associated metadata and/or parameters. Furthermore, the raw event sequences may each have variable lengths, and a clustering algorithm cannot draw any conclusion from the data without first embedding the raw event sequences into a standard fixed-length representation.

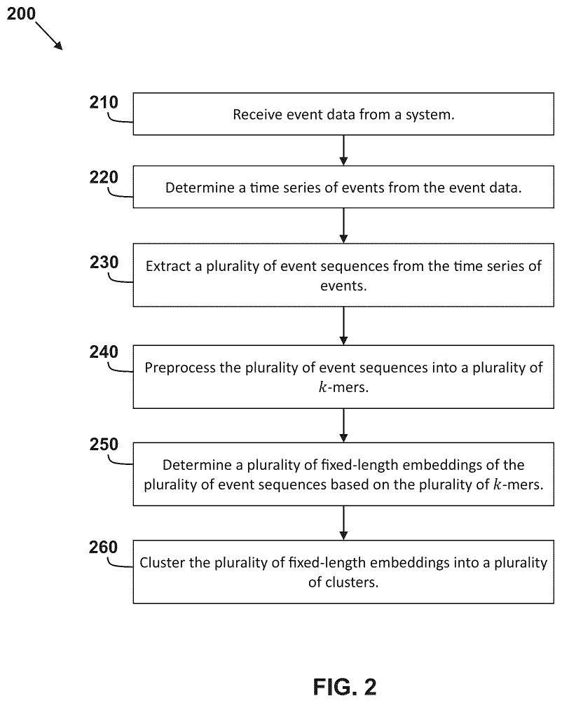

FIG. 2 shows a method 200 for performing a cluster analysis of event sequences in a system. The method 200 advantageously adopts a novel event sequence extraction scheme. The event sequence extraction scheme extracts event sequences from the event data stream 106 from a manufacturing plant by dividing the event stream into event sequences that end with interruptions so that the engineers can understand which anomalies are linked to the occurrence of the interruptions. Additionally, to more effectively cluster the extracted event sequences, the method 200 adopts advantageously two different novel embedding pipelines, referred to herein as Efficient Sequence Embedding in Euclidean Space (ESE-E) and Efficient Sequence Embedding in Latent Space (ESE-L), to provide fixed-length numerical representations of the event sequences extracted from the event data stream 106. Given an event sequence, ESE-E counts the occurrences of k-mers (subsequence of length k) while ESE-L operates by computing a kernel (similarity) matrix. The representations from both ESE-E and ESE-L are used as input for a clustering algorithm, such as K-means. The ESE-E and ESE-L embedding pipelines are advantageously alignment-free, which does not require a one-to-one mapping of sequence values and thus can be applied over a variety of data. The ESE-E and ESE-L embedding pipelines also preserve the order of values within event sequences, which can capture implicit patterns, improving clustering performance. The computations required for the ESE-E and ESE-L embedding pipelines are also sufficiently fast, reliable, and efficient in terms of clustering quality.

The method 200 begins with receiving event data from a system (block 210). Particularly, the processor 110 receives the event data stream(s) 106 from the monitored system 104. As discussed above, the event data stream(s) 106 at least includes data indicating events that occurred in the monitored system 104 and timestamps indicating the times at which the events occurred. Additionally, the event data stream(s) 106 may further include certain metadata, as discussed above. In at least some embodiments, the processor 110 stores the events from the event data stream(s) 106 in the database 102 (i.e., the event data 160).

With respect to the illustrative embodiment of a manufacturing plant, the different events, i.e., anomalies and interruptions, are distinguished from one another by either a unique code (for interruptions) or by the rules and affected component that define the event (for anomalies). Interruptions are assigned a code (e.g., ‘i114,’ ‘i212,’ etc.), based on what the line operators or engineers diagnosed the interruption as. Anomalies will have an affected part and a rule. The affected part is the machine component that has experienced the anomaly. The rule is the manner in which the affected component is behaving anomalously (e.g., exceeding a threshold), or how the data is behaving. These affected parts or rules relating to the anomaly may also be represented as a code (e.g., ‘a1768,’ ‘a2097,’ etc.). Interruptions can be differentiated based on their code, and anomalies can be differentiated based on what type of rule is being detected at what machine component. It can be the case that two different rules are detected at the same machine component, in which case, there will be two anomalies.

The method 200 continues with determining a time series of events from the event data (block 220). Particularly, the processor 110 determines a chronological time series of events from the event data stream(s) 106. The events in the event data stream(s) 106 may or may not be provided in chronological order and may be provided in the form of multiple different event data streams 106 from multiple different sources of event data in the monitored system 104. In addition to chronologically ordering the events, the processor 110 also categorizes the events into a standard type schema. Particularly, the events in the event data stream(s) 106 can be logically categorized into some number of predetermined event types that are suitable to domain of the monitored system 104. The event data stream(s) 106 may be received in a labeled or unlabeled form. Thus, in some embodiments, the processor 110 categorizes the events into a plurality of categories based on a predetermined ruleset. In the illustrative example of a manufacturing plant, the processor 110 categorizes and labels the events from the event data stream(s) 106 as two event types: “anomalies” and “interruptions.” In this way, the processor 110 combines and homogenizes all of the event data received from the monitored system 104 into a single chronological time series of events (i.e., a timeline), so that events sequences and events patterns can be extracted and mined from the event data 160.

The method 200 continues with extracting a plurality of event sequences from the time series of events (block 230). Particularly, once the chronological time series of events (i.e., the timeline) is constructed, the processor 110 extracts a plurality of event sequences. Each event sequence comprises a subset of sequential events from the chronological time series of events. In at least some embodiments, the processor 110 extracts the sequences according to a predetermined ruleset that is applied depending the event types of the events in the chronological time series of events. In some embodiments, the processor 110 extracts the plurality of event sequences such that each event sequence begins with at least one event sequential of a first event type (e.g., anomalies) and ends with at least one sequential event of a second event type (e.g., interruptions). In some embodiments, the processor 110 extracts the plurality of event sequences such that a time between a last event and a first event in the respective event sequence is less than a predetermined maximum time range (e.g., one week).

Before cluster analysis can be performed on the event data 160, the system 10 first requires event sequences to be extracted from the event data 160. The event sequences are structured sequences of ordered events. An event Ey can be defined as any anomaly or interruption that occurs at any location. As discussed above, these events can be temporally organized on a timeline using their timestamps. However, it is necessary to understand how to organize the events into an event sequence such that the sequences provide significant results.

In the illustrative example of a manufacturing plant, there are two types of events: anomalies and interruptions. It is the case that an anomaly may be related to a following set of interruptions. Thus, an event sequence can be defined such that it begins with an anomaly and includes the events up to the interruption(s), for a given time range. Thus, in the illustrative example of a manufacturing plant, event sequences may be defined and extracted as follows. Particularly, let I=i₁, i₂, . . . , iₙ be the set of all interruptions, and A=a₁, a₂, . . . , aₙ be the set of all anomalies. An event sequence is defined as S=<s₁, s₂, . . . , sₙ> where there is some index k<n such that for all i≤k, sᵢ⊆A, and for all j>k, sⱼ⊇I. In other words, the sequences are formed by an unbroken sequence of one or more anomalies, followed by an unbroken sequence of one or more interruptions, all within a maximum time range (e.g., one week).

The rationale for including all successive interruptions (sₖ₊₁ . . . sₙ) is that if multiple interruptions occur, with no anomaly occurring between them, then all of those interruptions might all be related to the initial anomaly. Once a new anomaly happens, the processor 110 begins forming a new sequence and future interruptions belong to the new sequence instead. In the illustrative example, the predetermined maximum time range may, for example, be one week based on an assumption that an interruption that occurs outside this window is no longer related to the anomaly.

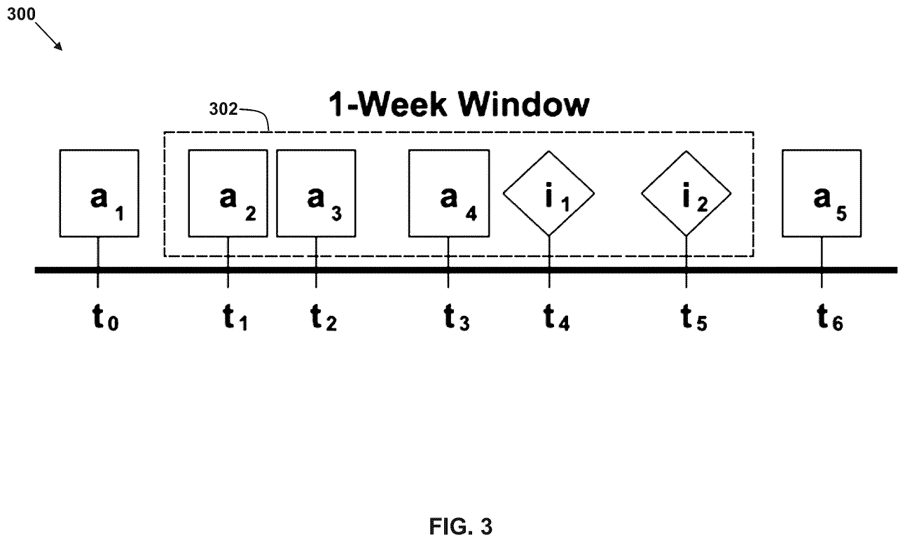

FIG. 3 depicts an event sequence 302 on a partial timeline 300. In the partial timeline 300, there are seven events that occur at respective times t₀, t₁, t₂, t₃, t₄, t₅, and t₆. The events occurring at times t₀, t₁, t₂, t₃, and to are anomalies (denoted by squares with an ‘aᵢ’) and the events occurring at times t₄, and t₅ are interruptions (denoted by diamonds with an ‘iᵢ’). At time t₀, the first anomaly occurs, followed by 3 more anomalies at times t₁, t₂, and t₃. The first interruption occurs at time t₄. At this point, the anomalies that occurred within one week of t₄ are included in an event sequence 302. In the illustration, the events at times t₁, t₂, and t₃ are all within one week, and so they are included in the event sequence 302 (denoted by the box that encompasses a subset of the events). The event at t₀, although occurring before the interruption, falls outside of the one-week window, and is thus not included in the event sequence 302. Following this, another interruption occurs at time t₅. Since no anomaly has yet occurred to signal a new event sequence, this interruption is included in the current event sequence 302. Finally, at t₆, a new anomaly occurs, signaling the end of the current event sequence 302 and potential creation of a new event sequence.

In at least some embodiments, the processor 110 further determines plurality of parameter sequences. Each parameter sequences is formed by at least one parameter associated with each event in a respective event sequence from the plurality of event sequences. Thus, for each event sequence S=<s₁, s₂, . . . , sₙ>, the processor 110 also determines a corresponding parameter sequence S₍ₚₐᵣₐₘ₎=<p₁, p₂, . . . , pₙ>, where pᵢ is a parameter of the event sᵢ in the corresponding event sequence S. The parameter included in the parameter sequences may include or be determined based on any piece of data from the metadata (discussed above) associated with the event. With these parameters, the system can better characterize the anomalies and interruptions inside our sequences. In one embodiment, to preserve confidential information of manufacturing lines and relevant systems, the processor 110 anonymizes the actual interruptions and anomaly in a given event sequence S and the associated parameters in S₍ₚₐᵣₐₘ₎, such that the event sequence S and the parameter sequence S₍ₚₐᵣₐₘ₎ are formed with anonymized values.

Returning to FIG. 2, the method 200 continues with preprocessing the plurality of event sequences into a plurality of k-mers (block 240). Particularly, for each event sequence in the plurality of event sequences, the processor 110 determines a plurality of fixed-length event subsequences, referred to herein as event k-mers (or n-grams), from the respective event sequence. Additionally, for each parameter sequence in the plurality of parameter sequences, the processor 110 determines a plurality of fixed-length event subsequences, referred to herein as parameter k-mers (or n-grams), from the respective parameter sequence. Each the plurality of event k-mers and the plurality of parameter k-mers have a same length k (e.g., 3). The length k of the k-mers is a learnable parameter and any value can be considered and used if needed.

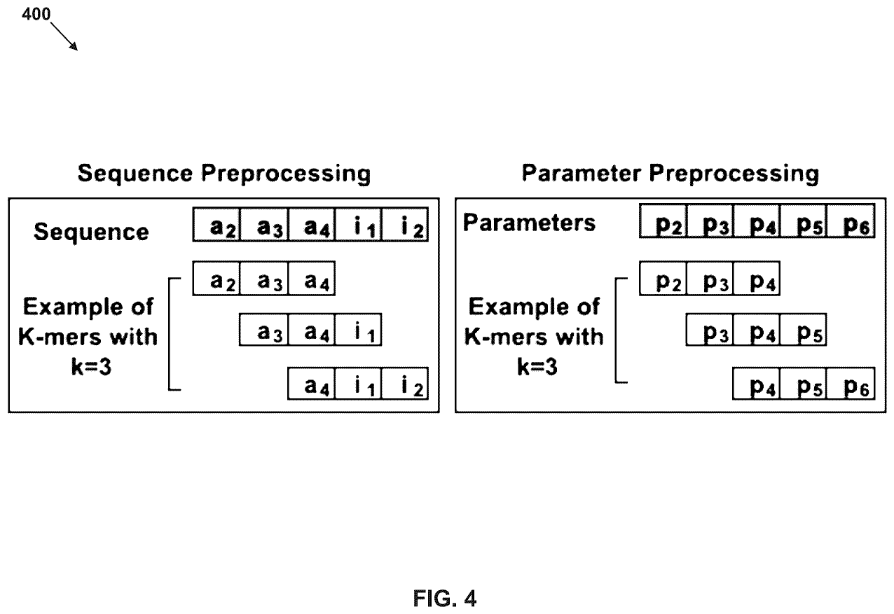

FIG. 4 summarizes the preprocessing 400 of event sequences and parameter sequences in fixed-length k-mers. As discussed above, for each event sequence S, there is a corresponding parameter sequence S₍ₚₐᵣₐₘ₎. However, as noted above, the event sequences S, and likewise the corresponding parameter sequences S₍ₚₐᵣₐₘ₎, can have variable lengths. For this reason, the sequences S and S₍ₚₐᵣₐₘ₎ are first transformed fixed-length k-mers. In the illustration, an event sequence S₁ is formed from a sequence of anomaly events a₂, a₃, a₄ which are followed by a sequence of interruption events i₁, i₂, i.e., S₁=<a₂, a₃, a₄, i₁, i₂>. Each event has some parameter value pᵢ which form a corresponding parameter sequence S₁_{₍ₚₐᵣₐₘ₎}=<p₂, p₃, p₄, p₅, p₆>. The parameters of S₁_{₍ₚₐᵣₐₘ₎} have a one-to-one association events of event sequence S₁ with corresponding events of event sequence S₁, i.e., p₂ is associated with a₂ and so on.

In the example, the processor 110 preprocesses the event sequence S₁ and the corresponding parameter sequence S₁ (param) by dividing them into three k-mers each of length k=3. Particularly, the event sequence S₁ is broken into the three event k-mers: (1) a₂, a₃, a₄, (2) a₃, a₄, i₁, and (3) a₄, i₁, i₂. Likewise, the parameter sequence S₁_{₍ₚₐᵣₐₘ₎} is broken into the three parameter k-mers: (1) p₂, p₃, p₄, (2) p₃, p₄, p₅, and (3) p₄, p₅, p₆.

As can be seen from the example, in at least some embodiments, the processor 110 determines the k-mers from each event sequence and corresponding parameter sequence using a sliding window approach, in which each k-mer has a length corresponding to a window length (e.g., 3) and each k-mer is determined by sliding the window by an predetermined interval (e.g., 1). Thus, the number of k-mers in a given sequence of length n is as follows: total k-mers=n−k+1.

It should be appreciated that, when the minimum length of sequences is very small, i.e., smaller than the value of optimal k, then such very short sequences cannot be divided into multiple fixed length k-mers. Instead, in some embodiments, when a sequence has a length n that is less than the optimal k, the processor 110 generates a single k-mer for the sequence by adding padding values, e.g., any default or dummy characters in sequences, to the sequence so that a k-mer can still be derived when the length of a sequence is too short.

Returning to FIG. 2, the method 200 continues with determining a plurality of fixed-length embeddings of the plurality of event sequences based on the plurality of k-mers (block 250). Particularly, the processor 110 determines a plurality of fixed-length embeddings representing the plurality of event sequences. More particularly, the processor 110 determines the plurality of fixed-length embeddings based on the plurality of event k-mers and the plurality of parameter k-mers, which resulted from the pre-processing of the plurality of event sequences and plurality of parameter sequences.

Although a variety of embedding techniques might be adopted to generate fixed-length embeddings representing the plurality of event sequences, two different exemplary sequence embedding pipelines are discussed in detail herein, referred to as Efficient Sequence Embedding in Euclidean Space (ESE-E) and Efficient Sequence Embedding in Latent Space (ESE-L).

In the exemplary ESE-E embedding pipeline, the processor 110 determines a plurality of fixed-length embeddings Φ_{ESE-E-freq} representing the plurality of event sequences S. In summary, for each event sequence S, the processor 110 determines an event frequency vector Φ_{seq} based on the k-mers of the event sequence S and determines a parameter frequency vector Φₚₐᵣₐₘ based on the k-mers of the corresponding parameter sequence S₍ₚₐᵣₐₘ₎. The processor 110 determines the final fixed-length embedding Φ_{ESE-E-freq} for the event sequence S based on the event frequency vector Φ_{seq} and the parameter frequency vector Φₚₐᵣₐₘ (e.g., by concatenation). In this way, by employing k-mers, the ESE-E embedding pipeline builds fixed-length embedding while preserving sequential ordering information of values in sequences.

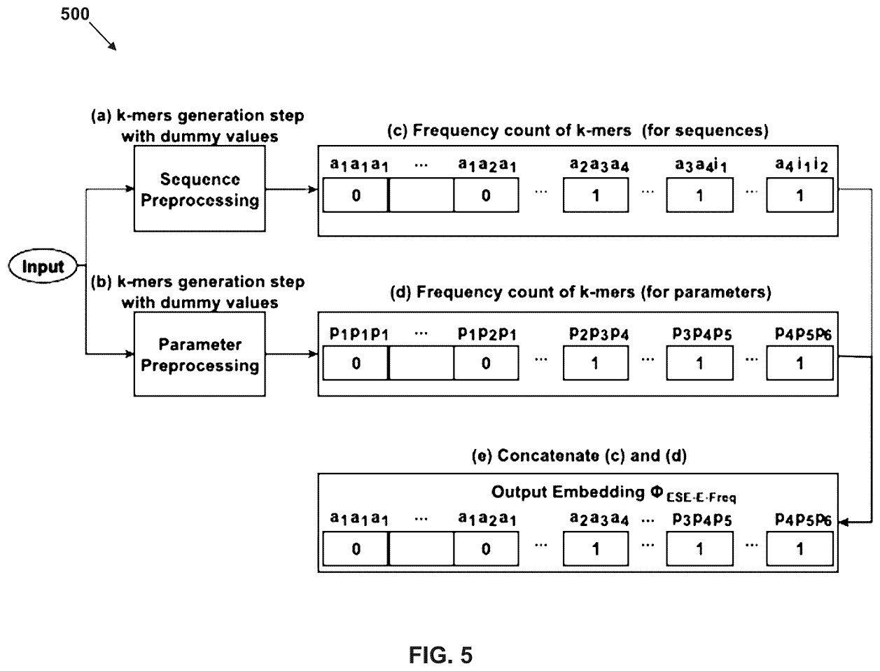

FIG. 5 summarizes the processing for the ESE-E embedding pipeline 500. The processor 110 computes the event frequency vector Φ_{seq} based on the k-mers of the event sequence S. The event frequency vector Φ_{seq} has a length |Σ|^{k}, where Σ corresponds to the event alphabet (set of all possible anomalies and interruptions in the data) and k is the length of the k-mers. The event frequency vector Φ_{seq} is comprised of values indicating a number of occurrences (or frequency) of each possible k-mer or, in other words, each possible event subsequence of length k, in the event sequences S. In the illustration, a processing of the event sequence S₁=<a₂, a₃, a₄, i₁, i₂> is shown. In section (c) of the illustration, the values in each bin of the indicate the count of corresponding k-mer in the input event sequence S₁, which collectively form the event frequency vector Φseq. As can be seen, event frequency vector Φ_{seq} has values ‘1’ corresponding to the three event k-mers a₂a₃a₄, a₃a₄i₁, and a₄i₁i₂ in the event sequences S and values ‘0’ for each other possible event k-mer.

Similarly, the processor 110 computes the parameter frequency vector Φₚₐᵣₐₘ based on the k-mers of the parameter sequence S₍ₚₐᵣₐₘ₎. The parameter frequency vector Φ_{seq} has a length |Σ|^{k}, where Σ corresponds to the parameter alphabet (set of all possible parameter values in the data) and k is the length of the k-mers. The parameter frequency vector Φₚₐᵣₐₘ is comprised of values indicating a number of occurrences (or frequency) of each possible k-mers or, in other words, each possible event subsequence of length k, in the parameter sequences S₍ₚₐᵣₐₘ₎. In the illustration, the processing of the parameter sequence S₍ₚₐᵣₐₘ₎=<p₂,p₃,p₄,p₅,p₆> is shown. In section (d) of the illustration, the values in each bin of the indicate the count of corresponding k-mer in the input parameter sequence S₍ₚₐᵣₐₘ₎, which collectively form the parameter frequency vector Φₚₐᵣₐₘ. As can be seen, the parameter frequency vector Φₚₐᵣₐₘ has values ‘1’ corresponding to the three parameter k-mers p₂p₃p₄, p₃p₄p₅, and p₄p₅p₆ in the parameter sequences S₍ₚₐᵣₐₘ₎ and values ‘0’ for each other possible parameter k-mer.

Finally, after determining the event frequency vector Φ_{seq} and the parameter frequency vector Φₚₐᵣₐₘ, the processor 110 determines the final fixed-length embedding Φ_{ESE-E-freq} by concatenating the event frequency vector Φ_{seq} with the parameter frequency vector Φₚₐᵣₐₘ. The processor 110 repeats these processes for each event sequence in the plurality of event sequences to determine a plurality of final fixed-length embedding Φ_{ESE-E-freq}.

It should be appreciated that there are many clustering algorithms, such as K-means and K-modes etc. The simplest and the most common clustering algorithm is the K-means clustering algorithm. The K-means clustering algorithm is considered as a linear clustering algorithm. However, the input event data can often be non-linear. Accordingly, if a linear clustering algorithm such as K-means is to be used, then it may be important to =transform the event sequences in such a manner that the linear clustering algorithm can be properly applied to on the non-linear event data. In contrast to the ESE-E embedding pipeline, the exemplary ESE-L embedding pipeline addresses this issue by adopting a kernel matrix to transform the non-linear decision surface to a linear equation in a higher numbered dimension space. By using the kernel matrix, the ESE-L embedding pipeline allows linear clustering algorithms to be easily applied to the non-linear event data.

In summary, in the exemplary ESE-L embedding pipeline, the processor 110 determines a k,m-mismatch kernel matrix, having values indicating a similarity between each possible combination of two event sequences in the plurality of event sequences S, based on the k-mers of the plurality of event sequences S. Next, for each event sequence S, the processor 110 determines a kernel vector Φₖₑᵣₙₑₗ for the event sequence S based on the k,m-mismatch kernel matrix and determines a parameter frequency vector Φₚₐᵣₐₘ based on the k-mers of the corresponding parameter sequence S₍ₚₐᵣₐₘ₎. The processor 110 determines the final fixed-length embedding Φ_{ESE-L-freq} for the event sequence S based on the kernel vector Φₖₑᵣₙₑₗ and the parameter frequency vector Φₚₐᵣₐₘ (e.g., by concatenation).

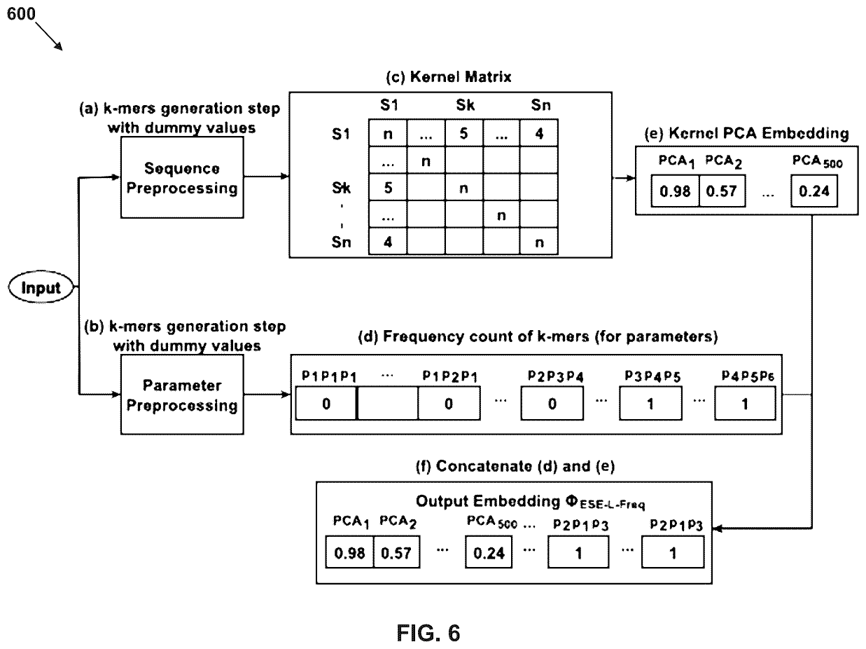

FIG. 6 summarizes the processing for the ESE-L embedding pipeline 600. First, the processor 110 computes a k,m-mismatch kernel matrix having values indicating a similarity between each possible combination of two event sequences in the plurality of event sequences S, based on the k-mers of the plurality of event sequences S. The k,m-mismatch kernel matrix has dimensions n×n, wherein n is the total number of event sequences. The values of the k,m-mismatch kernel matrix are determined based on the approximate distance between each pair of event sequences. Since computing kernel values one-by-one is computationally very expensive, in one embodiment, the processor 110 uses an approximate kernel computation method to speed up the process, such as the approximate kernel computation method described in the publication “Efficient Approximation Algorithms for String Kernel Based Sequence Classification” by Farhan et al., Conference on Neural Information Processing Systems (NIPS 2017). The kernel computation algorithm works by computing the distance (kernel value) between sequences using the number of matches and mismatches between characters from k-mers (also called k,m-mismatch spectrum) in each pair of event sequences and then a taking a dot product. This process is repeated for each pair of event sequences in the plurality of event sequences S.

More particularly, in one embodiment, for each event sequence S, the processor 110 determines a k,m-mismatch spectrum vector Φ_{k,m}(S). The values of k,m-mismatch spectrum vector Φ_{k,m}(S) indicate a number of times each possible k-mer occurs in the respective event sequence S with at m mismatches or less. More formally, given an event sequence S over alphabet Σ, the k,m-mismatch spectrum vector Φ_{k,m}(S) determined as follows:

$${Φ}_{k , m} ( S ) = {( {Φ}_{k , m} ( S ) [ γ ] )}_{γ ∈ {\sum }^{k}} = {\sum }_{α ∈ S} {{I}_{m} ( α , γ )}_{γ ∈ {\sum }^{k}}$$

where α is a k-mer from S and γ is a k-mer from Σ^{k} (all possible k-mers in the alphabet Σ) and the identity function Iₘ(α,γ)=1, if α is a k-mers that differ from γ by at most m mismatches, i.e. the Hamming distance between α and γ, d(α,γ)≤m. Otherwise, the identity function Iₘ(α,γ)=0 if there are more than m mismatches. In one example of the ESE-L embedding pipeline 600, the adjustable/learnable parameters k=3 and m=0 are used for the k,m-mismatch kernel matrix computation. However, a variety of values may be used. Note that for m=0, Φ_{k,m} (S) is known as k-spectrum of S and is identical to the event frequency vector Φ_{seq}(S) formed in the manner described above.

To determine the k,m-mismatch kernel values K (or mismatch spectrum similarity scores) of the k,m-mismatch kernel matrix, the processor 110 compares the k,m-mismatch spectrum vectors for each combination of two event sequences in the plurality of event sequences. In particular, given a combination of two sequences S₁ and S₂, the processor 110 determines k,m-mismatch spectrum vectors Φ_{k,m}(S₁) and Φ_{k,m}(S₂) and determines the k,m-mismatch kernel value K(S₁,S₂|k,m) as a dot product of the k,m-mismatch spectrum vectors Φ_{k,m}(S₁) and Φ_{k,m}(S₂). It should be appreciated that, using the equation above for Φ_{k,m}(S), this two-step process can be equivalently collapsed into one equation for determining K(S₁,S₂|k,m), as follows:

$$\begin{matrix}K ( {S}_{1} , {S}_{2} \vert k , m ) = 〈 {Φ}_{k , m} ( {S}_{1} ) , {Φ}_{k , m} ( {S}_{2} ) 〉 \\ = {\sum }_{γ ∈ {\sum }^{k}} {Φ}_{k , m} ( {S}_{1} ) [ γ ] {Φ}_{k , m} ( {S}_{2} ) [ γ ] \\ = {\sum }_{γ ∈ {\sum }^{k}} {\sum }_{α ∈ {S}_{1}} {I}_{m} ( α , γ ) {\sum }_{β ∈ {S}_{2}} {I}_{m} ( β , γ ) \\ = {\sum }_{α ∈ {S}_{1}} {\sum }_{β ∈ {S}_{2}} {\sum }_{γ ∈ {\sum }^{k}} {I}_{m} ( α , γ ) {I}_{m} ( β , γ )\end{matrix}$$

where α is a k-mer from S₁, β is a k-mer from S₂ and γ is a k-mer from Σ^{k}. In section (c) of the illustration, the values in each bin of the indicate the kernel value or similarity score of the respective combination of two events sequences.

As an illustrative example, consider a k-mer a₁a₂a₃ that is common to both S₁ and S₂. If the count (occurrence) of a₁a₂a₃ in S₁ is 3 and S₂ is 4, then the contribution a₁a₂a₃ towards the similarity value K(S₁,S₂|k,m) will be 3·4. This calculation is repeated for all k-mers that are common to both S₁ and S₂. It should be appreciated that the contribution of any k-mer that is not common to both S₁ and S₂ is 0. Thus, the final kernel/similarity value K(S₁,S₂|k,m) is the sum of such contributions from all k-mers that are common to both S₁ and S₂.

Next, for each event sequence S, the processor 110 determines a kernel vector Φₖₑᵣₙₑₗ for the respective event sequence S based on the k,m-mismatch kernel matrix by applying kernel principal component analysis (PCA) to the k,m-mismatch kernel matrix (getting top principal components for the respective event sequence S). The kernel PCA may, for example, be performed as described in the publication “Kernel PCA for novelty detection” by Hoffmann et al., Pattern recognition, vol. 40, no. 3, pp. 863-874 (2007). In section (e) of the illustration, the values in the bins indicate the top principal components for the respective event sequence S.

Additionally, for the parameter sequence S₍ₚₐᵣₐₘ₎ corresponding to each event sequence S, the processor 110 determines the parameter frequency vector Φₚₐᵣₐₘ based on the k-mers of the parameter sequence S₍ₚₐᵣₐₘ₎ in the same manner as discussed above with respect to the ESE-E embedding pipeline 500. In section (d) of the illustration, the values in each bin of the indicate the count of corresponding k-mer in the input parameter sequence S₍ₚₐᵣₐₘ₎, which collectively form the parameter frequency vector Φₚₐᵣₐₘ.

Finally, after determining the kernel vector Φₖₑᵣₙₑₗ and the parameter frequency vector Φₚₐᵣₐₘ, the processor 110 determines the final fixed-length embedding Φ_{ESE-L-freq} by concatenating the event the kernel vector Φₖₑᵣₙₑₗ with the parameter frequency vector Φₚₐᵣₐₘ. The processor 110 repeats these processes for each event sequence in the plurality of event sequences to determine a plurality of final fixed-length embeddings Φ_{ESE-L-freq}. By employing k-mers, the ESE-L embedding pipeline 600 builds fixed-length embedding while preserving sequential ordering information of values in sequences.

The method 200 continues with clustering the plurality of fixed-length embeddings into a plurality of clusters (block 260). Particularly, once the plurality of final fixed-length embeddings (i.e., Φ_{ESE-E-freq} or Φ_{ESE-L-freq}) are determined, the processor 110 performs a cluster analysis of the plurality of final fixed-length embeddings to determine a plurality of clusters of event sequences in the plurality of event sequences. In at least one embodiment, K-means or K-modes are used to cluster the final fixed-length embeddings. However, a wide variety of other linear and non-linear clustering algorithms can be adopted to cluster the final fixed-length embeddings.

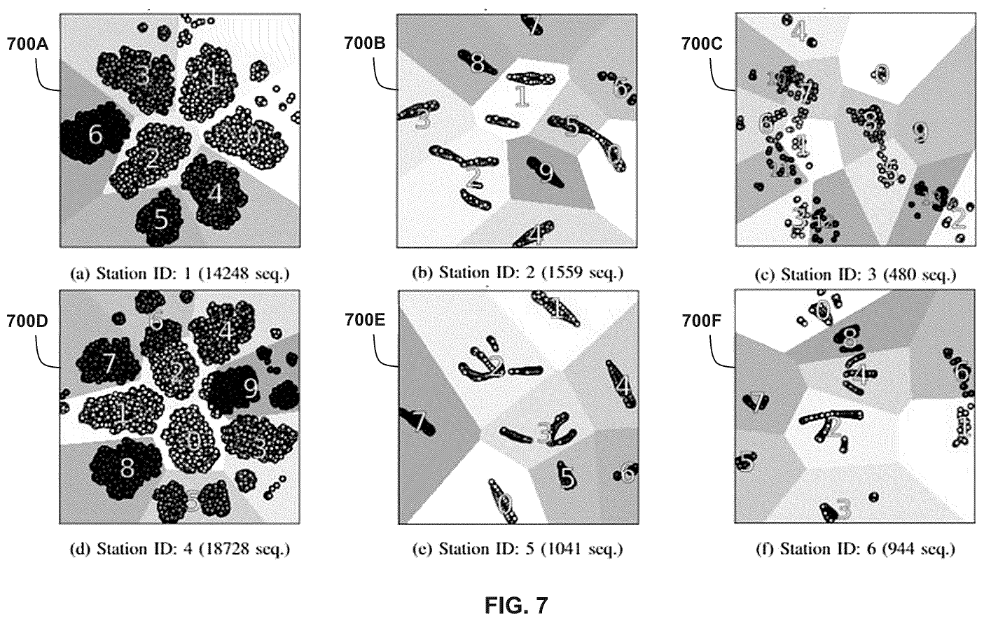

It will be appreciated by those of ordinary skill in the art that these clusters of event sequences can be utilized for a variety of advantageous and useful purposes. In at least one embodiment, the processor 110 operates the display screen 130 to display a graphical user interface that includes a graphical representation of the plurality of clusters of event sequences. FIG. 7 shows exemplary graphical representations 700A-F of clusters of event sequences from six different machine stations in a manufacturing plant. Each graphical representations 700A-F is plot including dots or circles representing individual event sequences. In the plot, the dots or circles representing individual event sequences are clustered together in accordance with the plurality of clusters of event sequences. The clusters are labeled with respective numbers or symbols. Using these graphical representations of the clusters of event sequences, an operator or engineer can learn of important patterns and trends occurring in the manufacturing plant (or other monitored system 104) to better understand the cause-and-effect relationships between events so that they can prevent undesirable events from occurring in the manufacturing plant.

Additionally, in some embodiments, the clusters of event sequences can be used for pattern detection and for predicting future behavior in the manufacturing plant (or other monitored system 104). In some embodiments, the processor 110 extracts common event patterns from the plurality of event sequences based on plurality of clusters of event sequences. In another embodiment, the processor 110 predicts a possible future event based on a partial event sequence and using the plurality of clusters of event sequences. Particularly, the processor 110 receives the event data stream(s) 106 from the monitored system 104 and extracts at least one partial event sequence. The processor 110 predicts a possible future event based on the partial event sequence indicating events that have already occurred and using the clusters of event sequences and/or the extracted patterns from the clusters of event sequences.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for analyzing events in a system, the method comprising:
receiving, with a processor, event data from the system, the event data indicating events that occurred in the system and times at which the events occurred;
determining, with the processor, a plurality of event sequences from the event data, the plurality of event sequences having variable lengths;
determining, with the processor, a plurality fixed-length embeddings of the plurality of event sequences; and
performing, with the processor, a cluster analysis of the fixed-length embeddings to determine a plurality of clusters of event sequences in the plurality of event sequences.

2. The method according to claim 1 further comprising:
determining, with the processor, a chronological time series of events from the event data,
wherein the plurality of event sequences is determined from the time series of events.

3. The method according to claim 2, wherein the event data includes multiple sets of event data from multiple sources of event data, the method further comprising:
combining the multiple sets of event data into the chronological time series of events.

4. The method according to claim 1 further comprising:
labeling, with the processor, each event from the event data as a respective event type from a predetermined set of event types.

5. The method according to claim 1, wherein the events of the event data include events of:
a first event type indicating that a measurable parameter of the system has a value that is outside of a predetermined or expected range; and
a second event type indicating that a process performed by the system is halted.

6. The method according to claim 1, the determining the plurality of event sequences further comprising:
forming each respective event sequence in the plurality of event sequences as a subset of sequential events from the event data.

7. The method according to claim 6, the determining the plurality of event sequences further comprising:
forming each respective event sequence in the plurality of event sequences such that the respective event sequence begins with at least one sequential event of a first event type and ends with at least one sequential event of a second event type.

8. The method according to claim 6, the determining the plurality of event sequences further comprising:
forming each respective event sequence in the plurality of event sequences such that a time between a last event and a first event in the respective event sequence is less than a predetermined maximum amount of time.

9. The method according to claim 1, wherein the event data further includes a respective parameter associated with each event in the event data, the method further comprising:
determining, with the processor, a plurality of parameter sequences, each parameter sequence being formed from the respective parameters associated with events in a respective event sequence from the plurality of event sequences,
wherein the plurality of fixed-length embeddings is determined based on the plurality of event sequences and plurality of parameter sequences.

10. The method according to claim 9, wherein the determining the plurality of fixed-length embeddings includes determining a respective fixed-length embedding of each respective event sequence in the plurality of event sequences by:
determining a plurality of fixed-length event subsequences from the respective event sequence;
determining a plurality of fixed-length parameter subsequences from a respective parameter sequence from the plurality of parameter sequences that is associated with the respective event sequence; and
determining the respective fixed-length embedding of the respective event sequence based on the plurality of fixed-length event subsequences and the fixed-length parameter subsequences.

11. The method according to claim 10, wherein the plurality of fixed-length event subsequences and the fixed-length parameter subsequences each have a same length.

12. The method according to claim 10, the determining the respective fixed-length embedding of the respective event sequence further comprising:
determining a first frequency vector based on the plurality of fixed-length parameter subsequences, the first frequency vector including values that each indicate a number of occurrences of a respective possible parameter subsequence in the plurality of fixed-length parameter subsequences;
determining a second frequency vector based on the plurality of fixed-length event subsequences, the second frequency vector including values that each indicate a number of occurrences of a respective possible event subsequence in the plurality of fixed-length event subsequences; and
determining the respective fixed-length embedding of the respective event sequence based on the first frequency vector and the second frequency vector.

13. The method according to claim 12, the determining the respective fixed-length embedding of the respective event sequence further comprising:
determining the respective fixed-length embedding of the respective event sequence as a concatenation of the first frequency vector and the second frequency vector.

14. The method according to claim 12, wherein:
the first frequency vector has a length equal to a total number possible parameter subsequences; and
the second frequency vector has a length equal to a total number possible event subsequences.

15. The method according to claim 10, the determining the plurality of fixed-length embeddings comprising:
determining a kernel matrix having values indicating a similarity between each possible combination of two event sequences in the plurality of event sequences; and
determining the respective fixed-length embedding of each respective event sequence in the plurality of event sequences by:
determining a first frequency vector based on the plurality of fixed-length parameter subsequences, the first frequency vector including values that each indicate a number of occurrences of a respective possible parameter subsequence in the plurality of fixed-length parameter subsequences;
determining a kernel vector for the respective event sequence the based on the kernel matrix; and
determining the respective fixed-length embedding of the respective event sequence based on the kernel vector and the first frequency vector.

16. The method according to claim 15, the determining the kernel matrix further comprising:
for each respective combination of two event sequences in the plurality of event sequences, determining a respective value in the kernel matrix for the respective combination of two event sequences by:
determining a respective second frequency vector, the respective second frequency vector including values that each indicate a number of occurrences, with a predetermined number of mismatches or less, of a respective possible event subsequence in the respective plurality of fixed-length event subsequences of a first event sequence in the respective combination of two event sequences;
determining a respective third frequency vector, the respective third frequency vector including values that each indicate a number of occurrences, with the predetermined number of mismatches or less, of a respective possible event subsequence in the respective plurality of fixed-length event subsequences of a second event sequence in the respective combination of two event sequences; and
determining the respective value in the kernel matrix for the respective combination of two event sequences as a dot product of the respective second frequency vector and the respective third frequency vector.

17. The method according to claim 15, the determining the kernel vector further comprising:
determining the kernel vector for the respective event sequence by applying kernel principal component analysis to the kernel matrix.

18. The method according to claim 1 further comprising:
displaying, on a display screen, at least some of the plurality of clusters of event sequences.

19. The method according to claim 1 further comprising:
extracting event patterns from the plurality of event sequences based on the plurality of clusters of event sequences.

20. The method according to claim 1 further comprising:
predicting, with the processor, a possible future event based on a partial event sequence and the plurality of clusters of event sequences.
